(19) United States
(12) Patent Application Publication
(10) Pub. No.: US 2014/0027577 A1
(43) Pub. Date: Jan. 30, 2014

(54) IMAGING SATELLITE SYSTEM AND METHOD

(71) Applicant: Dilip K. Darooka, West Chester, PA (US)

(72) Inventor: Dilip K. Darooka, West Chester, PA (US)

(73) Assignee: Alliant Techsystems Inc., Arlington, VA (US)

(21) Appl. No.: 13/559,321

(22) Filed: Jul. 26, 2012

(51) Int. Cl. B64G 1/44; B64G 1/40; B64G 1/28

(52) U.S. Cl. 244/165; 244/171.3

(57) ABSTRACT

A system and method for deploying a satellite having an integrated bus and an aperture, wherein the integrated bus extends along its longitudinal axis and wherein the aperture intersects the longitudinal axis. The satellite is deployed into an orbit, wherein deploying includes orienting the satellite so that the aperture points at a desired location. The satellite is spun so that the logitudinal axis and the aperture remain pointing at the desired location and data regarding the desired location is captured via the aperture.

### BACKGROUND

Micro-satellites or small-satellites have the capability to perform a variety of missions to meet reconnaissance and surveillance needs. They require, however, dedicated launch vehicles to meet the need on demand. A typical approach for launching the micro-satellites has been to rideshare with a larger primary payload. Alternatively, airborne launch vehicles have been proposed for launch on demand.

What is needed is an integrated micro-satellite system capable of being deployed via rideshare or airborne launch vehicle while still delivering high quality surveillance directly to the user.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates one example embodiment of a micro-satellite;

FIG. 2 illustrates another example embodiment of a micro-satellite;

FIG. 3 illustrates one example embodiment of an air launch vehicle carrying the micro-satellite of FIG. 2;

FIG. 4 illustrates another example embodiment of a micro-satellite;

FIG. 5 illustrates a method of deploying the micro-satellite of FIGS. 1, 2 and 4.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

As noted above, micro-satellites are used for reconnaissance and surveillance. It can be necessary to launch such satellites with little or no warning.

The Airborne Launch Assist Space Access (ALASA) program launched in 2012 by the Defense Advanced Research Projects Agency (DARPA) is aimed at getting satellites in the air quickly, cheaply, and from anywhere rather than from a limited number of launch sites. It is anticipated that airplane-based launch systems could get satellites into space on a 24-hour turnaround.

A dedicated launch of small satellites on airborne launch vehicles creates a paradigm shift in space utilization. Airborne launching of satellites has several advantages, including the ability to launch within hours of call-up, an increase in orbit accessibility (via the availability of multiple launch sites), and the ability to adapt the launch parameters to achieve the best orbit utilization for the given mission. However, in order to effectively utilize the airborne launch vehicle the micro-satellite must meet size, weight and power constraints. These constraints can be met via an integrated payload and bus configuration that fits within the launch vehicle while also meeting mission performance requirements at the lowest possible cost.

An integrated micro-satellite design can also be launched effectively in a rideshare mode on currently available launch vehicles. In one example embodiment, the micro-satellites are scalable; the satellite selected for launch is a function of the quality of surveillance imagery desired or expected.

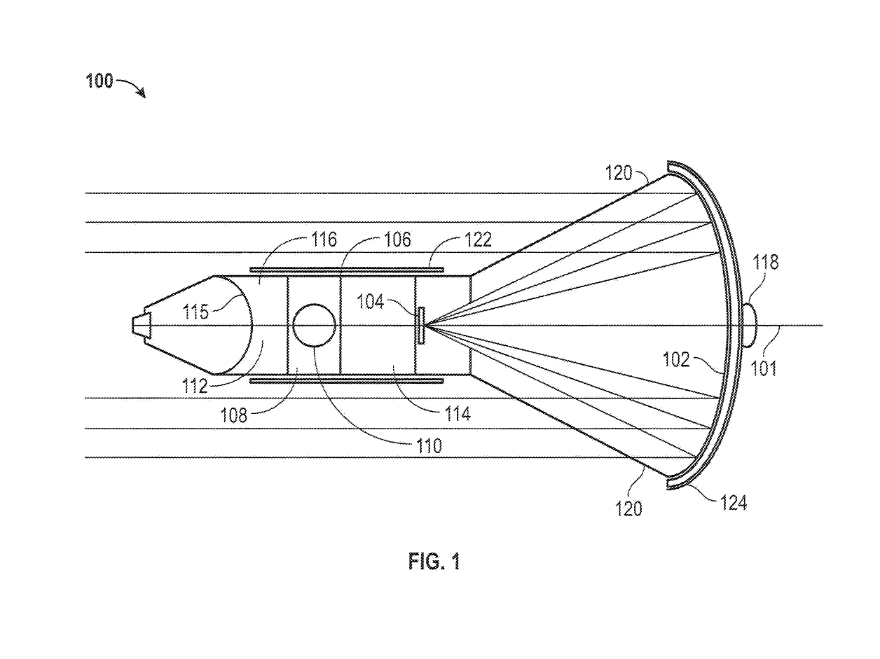

Some such micro-satellite systems are shown in FIGS. 1-5. Most air launch vehicles have an ogive fairing that restricts accommodation of the desired payload. FIGS. 1-5 illustrate scalable means of integrating the payload and the bus while effectively utilizing the shape and volume of the launch vehicle and at the same time maximizing the overall mission imaging capability.

One embodiment of a micro-satellite system capable of meeting the aforementioned requirements is shown in FIG. 1. In the embodiment shown in FIG. 1, micro-satellite system 100 includes a parabolic aperture 102, a focal plane array 104, and a bus 106, all located along a longitudinal axis 101. In one example embodiment, aperture 102 is a thermally stable composite dish separated from bus 106 via multifunctional struts 120. In the example embodiment shown, focal plane array 104 is an EO/IR focal plane array.

In one example embodiment, incoming radiation arrives approximately parallel to the longitudinal axis. Parabolic aperture 102 receives the incoming radiation and focuses it on focal plane array 104.

In the example shown, bus 106 is located in front of aperture 102. In one example embodiment, bus 106 includes an attitude control subsystem (ACS) 108, a propulsion subsystem 110, a command and data handling subsystem 112, a data processing and storage subsystem 114 and a power subsystem 116.

In the example embodiment shown in FIG. 1, a parabolic communication antenna 115 is mounted at the front end of bus 106. In one such embodiment, the communication antenna is sized to fit at the end of the bus. In one such embodiment, the cylindrical configuration of bus 106 and the placement of parabolic aperture 102 provide rotational symmetry so that the spacecraft 100 can be stabilized by spinning. In one such embodiment, the spinning of satellite 100 also tends to foster a uniform temperature on the parabolic aperture for reduced thermal distortion. In another example embodiment, bus 106 has a shape that approximates a slender rectangular prism, having a small cross-section along the longitudinal axis.

In one embodiment, bus 106 is miniaturized to impart minimum obstruction to radiation collection. As can be seen in FIG. 1, in one example embodiment bus 106 is approximately 0.1 meters in diameter

In one such embodiment, the cylindrical structure of the bus 106 as well as the back side of the parabolic aperture 102 allow direct mounting of solar arrays (122 and 124) such that a portion of the solar array is always pointed towards the Sun. In the example embodiment shown in FIG. 1, a GPS receiver 118 is mounted over solar array 124 at the back of aperture 102.

In one example embodiment, communications antenna 115 .of FIG. 1 has a diameter of approximately 10 cm, aperture 102 has a diameter of approximately 90 cm and the length of micro-satellite 100 is approximately 2 m, Micro-satellite system 100 can be scaled up or down as necessary to meet the mission parameters.

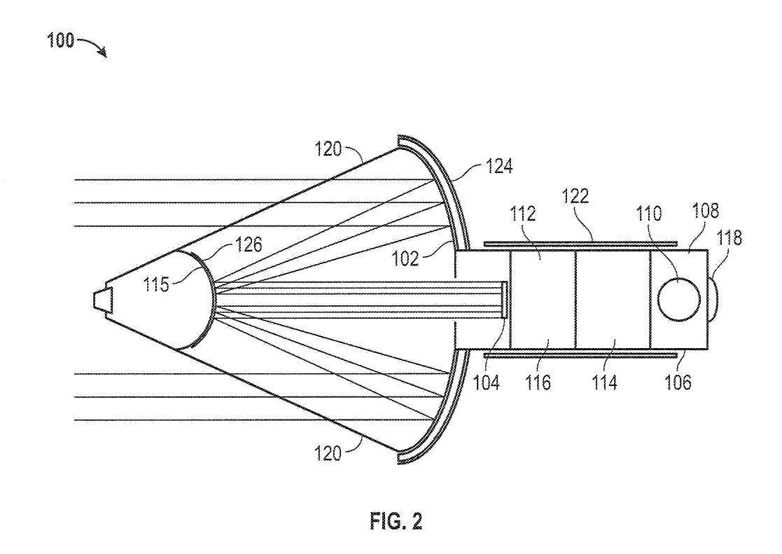

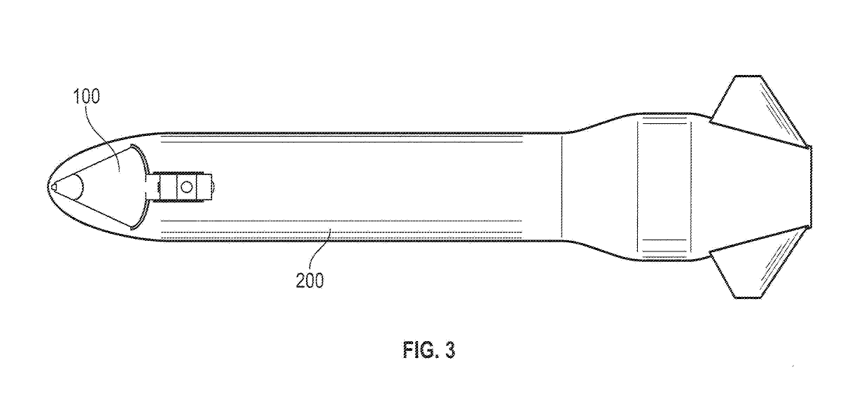

Another embodiment of a micro-satellite system 100 capable of air launch is shown in FIG. 2. In the Cassegrainian configuration shown in FIG. 2, the Focal Plane Array 104 is mounted on the same side as the parabolic aperture 102 (also refereed to as “primary reflector”). This results in much longer focal length, which in turn results in better ground separation distance (GSD) for imaging. In the example embodiment shown in FIG. 2, bus 106 is mounted on the longitudinal axis behind aperture 102 while the back side of the parabolic communication antenna 115 includes an optical reflector 126 (also known as the “secondary reflector”). As seen in FIG. 3, the example embodiment of satellite system 100 shown in FIG. 2 can be sized to fit inside the ogive fairing of a typical airborne launch vehicle 200. In the example embodiment shown in FIG. 2, bus 106 is approximately 0.1 meters in diameter.

In one example embodiment, communications antenna 115 of FIG. 2 has a diameter of approximately 10 cm, aperture 102 has a diameter of approximately 90 cm and the length of micro-satellite 100 is approximately 2 m, Micro-satellite system 100 can be scaled up or down as necessary to meet the mission parameters. In one such example embodiment, launch vehicle 200 is 264 inches in length and 36 inches in diameter along its main body but flares to 56 inches in diameter before reaching the fins.

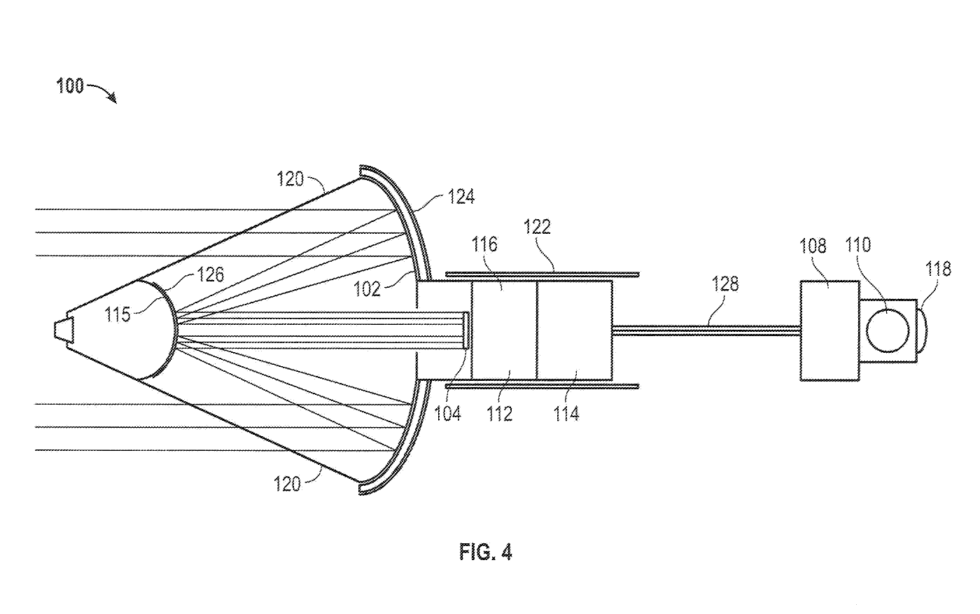

In yet another embodiment of micro-satellite system 100, as shown in FIG. 4, the propulsion and the attitude control subsystems (108, 110) are separated from the main bus structure by means of a deployable boom 128 (shown extended in FIG. 4). Lower system mass is achieved in this approach by making use of the gravity gradient torque to further stabilize and point spacecraft 100. Nadir pointing of spacecraft 100 results in lower drag for extended missions, requiring less fuel: By separating the propulsion system from the bus, the change in the size of the propulsion tank for longer and/or manevering missions is accomplished without affecting the size of the bus. Further, the amount of fuel required for attitude control is substantially reduced due to the advantage gained from the moment arm.

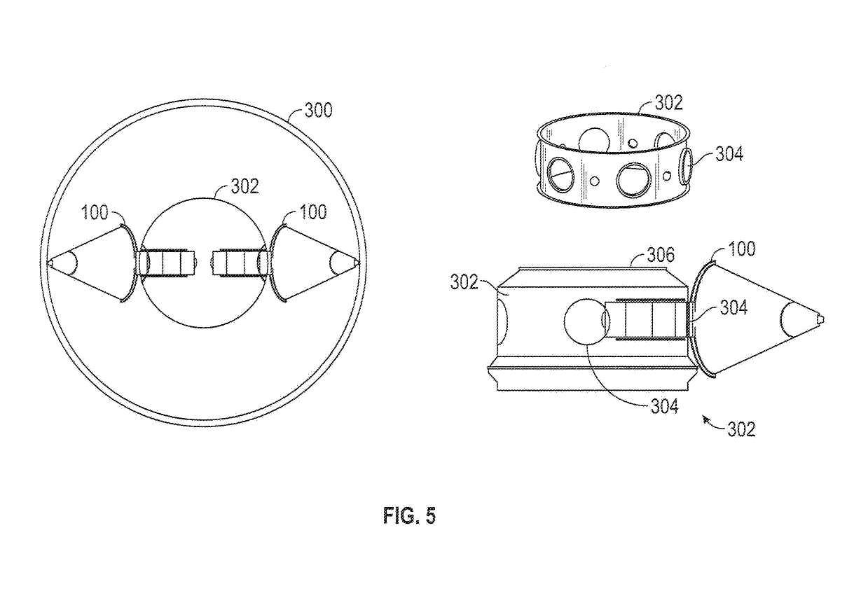

In one embodiment, micro-satellite is scaled to fit into the ESPA ring for a rideshare launch. Such an embodiment is shown in FIG. 5, where one or more satellites 100 are mounted on a standard ESPA ring 302 as part of a payload on a launch vehicle 300. Each ring 302 includes one or more clamp mechanisms 304 for holding the satellite 100 in place in ring 302.

In cone example embodiment, ring 302 is 1.5 meters in diameter while clamp mechanisms 304 have an internal diameter of approximately 38 cm. In such one embodiment bus 106 is designed to fit within clamp mechanism 304. In the embodiment shown in FIG. 5, aperture 102 is 90 cm in diameter. In operation, ring 302 is mounted on an LV adapter 306 within launch vehicle 300.

In one embodiment, the primary reflector (or the parabolic aperture) is designed to be deployable in space such that very large aperture may be employed to achieve even better imaging quality while being able to stow the micro-satellite in the launch vehicle occupying much smaller volume.

The micro-satellites described above provide a totally integrated solution of the payload and the bus functions that is scalable to fit in different air launch vehicles. It is capable of accommodating much larger apertures and, therefore, delivers superior imaging capability with better resolution. As is illustrated in FIG. 3, each micro-satellite can be tailored to fit its particular launch vehicle fairing in order to deliver the maximum possible capability in terms of resolution and data transfer. Similarly, as is illustrated in FIG. 5, each micro-satellite can be tailored to fit in an ESPA ring for lauch with a primary payload. In both case, the axially symmetric approach allows high degree of stability by spinning the satellite; stability can be further improved with gravity gradient assist. The overall impact is to deliver superior earth imagery anywhere on earth at a much lower cost and on demand.

The nadir-pointed, axially symmetric profile of the satellite results in. lower drag and better stability for extended life. In addition, mounting a solar array on an axially symmetric surface removes the requirement for articulation for Sun pointing of the solar array. Furthermore, the micro-satellites described above demonstrate better imaging resolution with lower system mass, with imaging in some example embodiments to NIIRS 5 level or above.

To date, there is no scalable means of integrating the payload and the bus into an airborne launch vehicle while effectively utilizing the shape and volume of the launch vehicle and, at the same time maximizing the overall mission imaging capability. The present system and method provide such a scalable means. Also, to date, there is no scalable means of integrating the payload and the bus into a micro-satellite which can be scaled as needed for a rideshare launch. The present system and method provide such scalable means.

The micro-satellites described above are scalable to fit inside a variety of air launch vehicles and tailorable to meet specific need. The integrated approach makes it so that a satellite can be launched at any time, and in some cases, within an hour of call up. They also can be launched from a variety of launch sites via a variety of airborne launch vehicles, which further increases flexibility of launch angle and launch altitude.

Although specific embodiments have been illustrated and described herein, it will be appreciated by those of ordinary skill in the art that any arrangement which is calculated to achieve the same purpose may be substituted for the specific embodiments shown. The invention may be implemented in various modules and in hardware, software, and various combinations thereof, and any combination of the features described in the examples presented herein is explicitly contemplated as an additional example embodiment. This application is intended to cover any adaptations or variations of the example embodiments of the invention described herein. It is intended that this invention be limited only by the claims, and the full scope of equivalents thereof.

What is claimed is:

1. A satellite having a longitudinal axis, comprising:
a bus, wherein the bus includes a power supply and wherein the bus includes subsystems for providing propulsion and attitude control, command and data handling, and data processing and storage, wherein the subsystems are arranged along the longitudinal axis;
an aperture which intersects the longitudinal axis, wherein the aperture receives incoming radiation arriving parallel to the longitudinal axis and focuses the incoming radiation to create focused radiation;
a focal plane array attached to the bus and configured to receive the focused radiation; and
a communication antenna which intersects the longitudinal axis;
wherein the satellite is configured to be rotationally symmetric such that the satellite can be stabilized by spinning the satellite around its longitudinal axis.

2. The satellite of claim 1, wherein the communication antenna is attached to one end of the bus.

3. The satellite of claim 1, wherein the communication antenna is placed in front of the aperture and is configured to reflect focused radiation from the aperture onto the focal plane array.

4. The satellite of claim 1, wherein the focal plane array is attached to one end of the bus and configured to receive focused radiation directly from the aperture.

5. The satellite of claim 1, wherein the focal plane array and the aperture are in a Cassegrainian arrangement.

6. The satellite of claim 1, wherein the satellite takes advantage of gravity gradient torques to further stabilize the satellite.

7. The satellite of claim 1, wherein the satellite includes a solar array mounted on a portion of the back of the aperture.

8. The satellite of claim 1, wherein the bus includes an extendable boom.

9. The satellite of claim 1, wherein the bus includes an extendable boom, wherein the boom, when extended, increases distance between the aperture and the subsystem that provides propulsion.

10. The satellite of claim 1, wherein the focal plane array and the aperture are in a Cassegrainian arrangement; and
wherein the communication antenna includes a reflective material which reflects the focused radiation onto the focal plane array.

11. The satellite of claim 1, wherein the bus has a roughly cylindrical shape extending in the longitudinal axis.

12. The satellite of claim 1, wherein the bus has a roughly rectangular prism shape extending in the longitudinal axis.

13. A method of deploying a satellite having a longitudinal axis, wherein the satellite includes an integrated bus and an aperture, wherein the integrated bus extends along the longitudinal axis and wherein the aperture intersects the longitudinal axis, the method comprising:
deploying the satellite into an orbit, wherein deploying includes orienting the satellite so that the aperture points at a desired location;
spinning the satellite so that the logitudinal axis and the aperture remain pointing at the desired location; and
capturing, via the aperture, data regarding the desired location.

14. The method of claim 13, wherein the bus includes an extendable boom that can be used to extend the length of the bus and wherein deploying includes extending the boom.

15. The method of claim 13, wherein deploying includes mounting the satellite on a standard ESPA ring and launching the satellite as a portion of a payload on a launch vehicle.

16. A satellite launch system, comprising:
a launch vehicle; and
a satellite mounted within the launch vehicle, wherein the satellite has a longitudinal axis and wherein the satellite includes:
a bus, wherein the bus includes two or more subsystems, wherein the subsystems control attitude, provide propulsion, process data and commands and supply power, wherein the two or more of the subsystems are arranged along the longitudinal axis;
an aperture which intersects the longitudinal axis, wherein the aperture receives incoming radiation arriving parallel to the longitudinal axis and focuses the incoming radiation to create focused radiation;
a focal plane array attached to the bus and configured to received the focused radiation; and
a communication antenna which intersects the longitudinal axis;
wherein the satellite is configured to be rotationally symmetric such that the satellite can be stabilized by spinning around the longitudinal axis.

17. The satellite launch system of claim 16, wherein the satellite is mounted to an ESPA ring and the ring is mounted within the launch vehicle.

18. The satellite launch system of claim 16, wherein the bus includes an extendable boom.

19. The satellite launch system of claim 16, wherein the focal plane array and the aperture are in a Cassegrainian arrangement; and
wherein the communication antenna includes a reflective material which reflects the focused radiation onto the focal plane array.

20. The satellite launch system of claim 16, wherein the bus includes an extendable boom, wherein the boom, when extended, increases distance between the aperture and the subsystem that provides propulsion.
